(19) United States
(12) Patent Application Publication
(10) Pub. No.: US 2025/0240396 A1
(43) Pub. Date: Jul. 24, 2025

(54) MULTI-CAMERA CAPTURE SYSTEM ACROSS MULTIPLE DEVICES

(71) Applicant: Google LLC, Mountain View, CA (US)

(72) Inventor: Dongeek Shin, San Jose, CA (US)

(21) Appl. No.: 19/032,940

(22) Filed: Jan. 21, 2025

Related U.S. Application Data
(60) Provisional application No. 63/622,394, filed on Jan. 18, 2024.

(51) Int. Cl. H04N 13/111; G06T 7/40; G06T 7/80; H04L 65/1089; H04L 65/403; H04N 13/194; H04N 13/239

(52) U.S. Cl. CPC H04N 13/111; G06T 7/40; G06T 7/85; H04L 65/1089; H04L 65/403; H04N 13/194; H04N 13/239; G06T 2207/10021; G06T 2207/30201; G06T 2207/30204; G06T 2207/30244

(57) ABSTRACT

Techniques include using a plurality of common electronic devices (e.g., laptops, tablet computers, smartphones, etc.) that have cameras to generate data for images at systems such as telepresence videoconferencing systems. For example, the devices having a camera can be situated with respect to a user to provide different perspectives. The cameras can capture images of the user from the different perspectives and generate image data based on the images. One of the devices can be designated as a host that receives the image data, processes the image data into frames, and transmits the frames to a telepresence videoconferencing system.

### CROSS REFERENCE TO RELATED APPLICATION

This application claims the benefit of U.S. Provisional Application No. 63/622,394, filed Jan. 18, 2024, the disclosure of which is incorporated herein by reference in its entirety.

### SUMMARY

Implementations described herein are related to lowering the cost of providing high-quality, three-dimensional images to remote locations. For example, an arrangement of cameras may be used to form a three-dimensional image of a person that is transmitted to a telepresence videoconferencing system at a remote location. Such an arrangement of cameras may be provided by everyday devices that a user may have on their person, e.g., a laptop, a tablet computer, a smartphone. One of the devices acts as a host that processes image data and sends the image data to the system at the remote location. The host and the devices may be arranged at different positions and orientations (poses) with respect to the user. After the devices are calibrated to the host, the devices can send image data representing images of the user taken from different perspectives to the host. The host processes the respective image data as it is received and generates frames of data to send to the system at the remote location via a network. In some implementations, the host reconstructs a three-dimensional image and compresses the three-dimensional image in each frame. In some implementation, the system at the remote location performs the reconstruction. The result is a low-cost transfer of three-dimensional images to a remote location.

In one general aspect, a method can include receiving, by a first host, image data based on an image of a three-dimensional object captured by a first device situated at a first pose relative to the first host. The method can also include generating frame data representing an image frame, the frame data being based on the image data and the first pose relative to the first host. The method can further include transmitting the frame data to a second host configured to reconstruct the image of the three-dimensional object from a perspective of a second device situated at a second pose relative to the first host.

In another general aspect, a system can include a first device, a first host, and a second host, each of which includes memory and processing circuitry coupled to the memory. The processing circuitry of the first device is configured to capture an image of a three-dimensional object. The processing circuitry of the first device is also configured to generate image data based on the image of the three-dimensional object. The processing circuitry of the first device is further configured to send the image data to a first host, wherein the first device is situated at a first pose relative to the first host. The processing circuitry of the first host is configured to receive the image data. The processing circuitry of the first host is also configured to generate frame data representing an image frame, the frame data being based on the image data and the first pose relative to the first host. The processing circuitry of the first host is further configured to transmit the frame data to a second host. The processing circuitry of the second host is configured to receive the frame data. The processing circuitry of the second host is also configured to reconstruct, from the frame data, the image of the three-dimensional object from a perspective of a second device situated at a second pose relative to the first host to produce a reconstructed frame.

The details of one or more implementations are set forth in the accompanying drawings and the description below. Other features will be apparent from the description and drawings, and from the claims.

### BRIEF DESCRIPTION OF THE DRAWINGS

FIG. 1A is a diagram that illustrates an example arrangement of a host and devices for creating and transmitting a representation of a three-dimensional image to a system at a remote location, according to an aspect.

FIG. 1B is a diagram that illustrates an example transmission of the representation of the three-dimensional image to a telepresence videoconferencing system, according to an aspect.

FIG. 2 is a diagram that illustrates an example electronic environment of a host, according to an aspect.

FIG. 3 is a diagram that illustrates an example electronic environment of a device, according to an aspect.

FIG. 4 is a diagram that illustrates an example electronic environment of a system at a remote location, according to an aspect.

FIG. 5 is a diagram that illustrates example image data used in reconstructing three-dimensional images and calibrating the devices to the host, according to an aspect.

FIGS. 6A, 6B, and 6C are diagrams that illustrate an example embedding timing diagram representing a timing of the acquiring of the embeddings in asynchronous devices such that a warping behavior is avoided, according to an aspect.

FIG. 7 is a flow chart that illustrates an example method of generating data for images at systems such as telepresence videoconferencing systems from at least one device.

### DETAILED DESCRIPTION

Telepresence refers to any set of technologies which allow a person to feel as if they were present, at a place other than their true location. Telepresence may involve a user's senses interacting with specific stimuli, e.g., visual, auditory, tactile, olfactory, etc. In applications such as telepresence videoconferencing, just visual and auditory stimuli are considered.

A telepresence videoconferencing system includes a display on which multiple cameras are arranged. The telepresence videoconferencing system is fixed within a room occupied by the user facing the display. The user facing the display sees a fellow participant of a telepresence videoconference. In some implementations, the image on the display seen by the user is configured such that the fellow participant appears to be occupying the room with the user. For example, the cameras may provide images of the user from different perspectives (e.g., angles); such information may be used to provide depth imaging information. Coupling the depth imaging information with texture information may be used to simulate a three-dimensional image of the user in a space occupied by the fellow participant of the telepresence videoconference.

The display may be a stereoscopic three-dimensional (3D) display. Stereoscopic 3D displays present a 3D image to an observer by sending a slightly different perspective view to each of an observer's two eyes, to provide an immersive experience to the observer. The visual system of an observer may process the two perspective images so as to interpret an image containing a perception of depth by invoking binocular stereopsis so the observer can see the image in 3D.

Because of the stereo imagery used to create an interpretation of depth, one obtains an accurate measure of a user's eyes relative to display coordinates. Such an accurate measure of the location of a user's eyes within the display requires knowledge of the six degrees of freedom (6 DoF) pose, i.e., three positional and three orientation coordinates of a camera-display transformation.

A technical problem with transmitting such images is that the images require a large amount of bandwidth. Moreover, the images may require expensive equipment for acquisition. For example, as described above, a telepresence videoconferencing system may have several cameras carefully calibrated for position and orientation to acquire such high-quality, three-dimensional images for transmission to another telepresence system. Such carefully calibrated cameras and stereoscopic 3D displays make for expensive equipment that may limit the use of telepresence videoconferencing systems.

A technical solution to the technical problem involves using a plurality of common electronic devices (e.g., laptops, tablet computers, smartphones, etc.) that have cameras to generate data for images at systems such as telepresence videoconferencing systems. For example, the devices having a camera can be situated with respect to a user to provide different perspectives. The cameras can capture images of the user from the different perspectives and generate image data based on the images. One of the devices can be designated as a host that receives the image data, processes the image data into frames, and transmits the frames to a telepresence videoconferencing system. In some implementations, in generating the image data, the images captured by the devices are broken down into data structures that represent the images but contain far less data than the images. In some implementations, at least one of the data structures may be used by the host to calibrate the devices with respect to the host. In some implementations, the telepresence videoconferencing system is configured to reconstruct a three-dimensional image from the frames from a perspective from one of the devices (e.g., the host).

A technical advantage of the technical solution is that the post-login user interface enables a user to restore tasks, applications, and settings, e.g., session items, from a previous session of the operating system with far fewer operations (interactions with the operating system) than a conventional operating system. Moreover, the user is enabled, via an informed restore user interface, to perform a partial restore of the previous session by selecting only some and not all session items from the previous session. Further, the user is enabled via smart suggestions to activate tasks that may or may not have been active in the previous session. Moreover, the smart suggestions can activate such tasks across different devices associated with the same user account.

It is noted that the images need not be sent to a telepresence videoconferencing system for reconstruction. For example, if both the sender and receiver are no longer using full telepresence capture facilities, then the reconstruction of the three-dimensional images can occur in, e.g., a virtual reality system.

A technical advantage of the technical solution lies in the ability to capture high-quality, three-dimensional images using common, low-cost electronic devices. This can bring down the cost of conducting telepresence meetings, for example. Moreover, the process of calibrating the devices is simplified by using some of the image data in a calibration process prior to processing and transmitting image frames to the telepresence videoconferencing system.

An image frame is image data from one or more devices that is collected by the host within a segment of time. For example, if a frame rate at which the host transmits frames to the telepresence videoconferencing system is 60 Hz, then the segment of time would be 1/60 of a second. In some implementations, the frame rate is based on a refresh rate of a display of the telepresence videoconferencing system. In some implementations, the host performs a reconstruction of each image from each device from the image data. In such implementations, the host then compresses each image prior to transmission to the telepresence videoconferencing system within an image frame.

In some implementations, the image data generated by the devices from the images includes data structures such as keypoints, landmarks or tracks, and texture embeddings. Keypoints are specified points of the user's head and/or face—or more generally, specified points of an object that is images by the devices. For example, keypoints can include a top of the head, a midpoint between the brows, a center of the eyes, a tip of the nose, ends of the mouth, and a bottom of the chin. The keypoints may be represented as coordinates in two or three dimensions. The keypoints may be sent from a device to a host for use in a calibration procedure that estimates a pose of the device with respect to the host.

Landmarks are specific attributes that enable the host or a device to distinguish between different faces. The landmarks represent contours of the parts of the user's face at designated parts of the face. The parts of the face that are included in landmarks may include the nose, eyebrow, chin, mouth, and eye corners. Each landmark may be represented by a set of points in two or three dimensions.

A texture embedding is an encoding of skin and lighting details of a face. A texture embedding is created from a pixel representation of the face. Each pixel of the pixel representation of the face includes information such as a color (e.g., in RGB representation) and the lighting (e.g., bidirectional reflectance distribution function). The pixel representation is then input into a model, e.g., a convolutional neural network encoder, to generate a texture embedding. The texture embedding is a vector of numbers representing the pixel representation having a dimension that is smaller than that of the original pixel representation; thus, the texture embedding represents a large reduction of data.

Once the poses of the devices are estimated from the keypoints in a calibration procedure, the devices send their respective landmarks and texture embeddings to the host device as image data. In some implementations, however, the host device derives landmarks and texture embeddings from images sent from each of the devices. In some implementations, the host device then sends the landmarks and texture embeddings received within a segment of time within a frame to a telepresence device for reconstruction to a three-dimensional image.

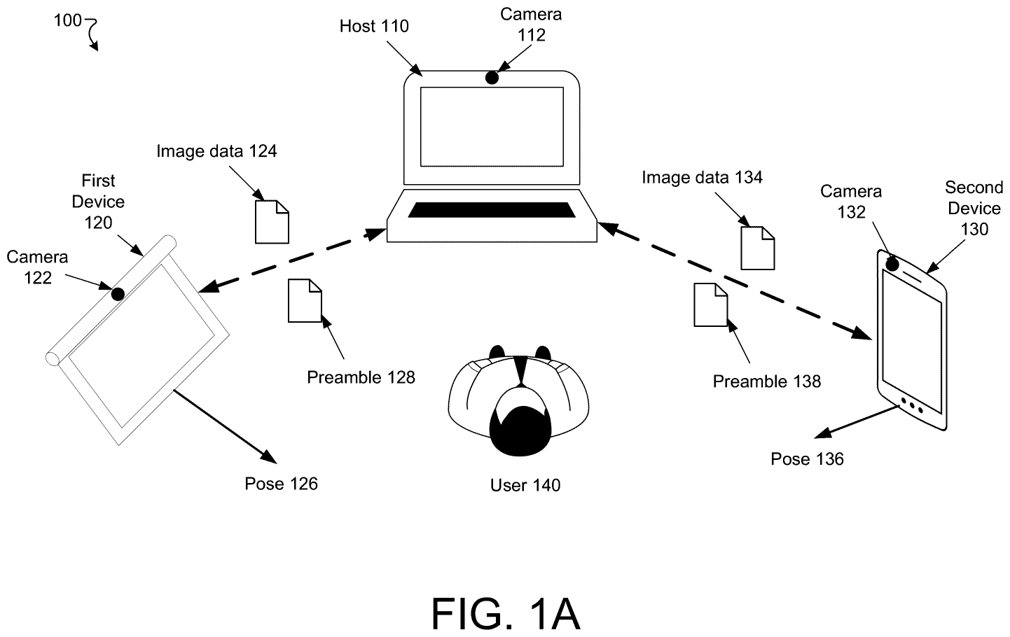

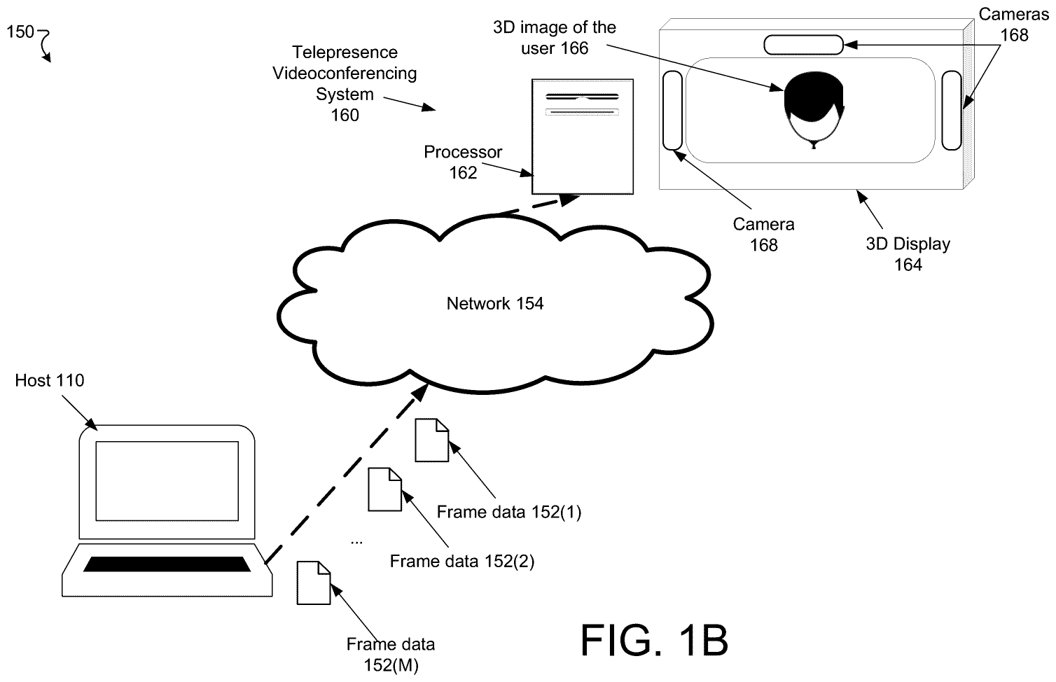

FIG. 1A is a diagram that illustrates an example arrangement 100 of a host 110, first device 120, and second device 130 for creating and transmitting a representation of a three-dimensional image of a three-dimensional object such as a face of a user 140 to a system at a remote location. The example arrangement 100, as shown in FIG. 1A, has two devices and a host, e.g., a telepresence videoconferencing system 160 (FIG. 1B). This example is not meant to be limiting and there can be any number of devices, e.g., one, three, four, five, and so on. In the arrangement 100, the devices 120 and 130 and the host 110 are connected via a local network, e.g., WiFi, Bluetooth, cellular connection.

It is noted that in arrangement 100, the host 110 is a laptop while the first device 120 is a tablet computer and the second device 130 is a smartphone. In principle, in any collection of devices used to generate data for three-dimensional images as discussed herein the host may be selected from the collection arbitrarily. In some implementations, however, the host is selected according to a criterion, e.g., as the device with the greatest amount of computational resources (e.g., processing power, memory). In some implementations, the selection may be performed manually. In some implementations, the selection is performed automatically.

Each of the host 110, the first device 120, and the second device 130 have respective cameras 112, 122, and 132. Any device that is used generate data for three-dimensional (3D) images as discussed herein has a camera. While in some implementations, the host 110 is not involved in generating image data for frames, in such implementations the host 110 may be involved in calibrating the first device 120 and the second device 130 to determine pose with respect to the host 110 and would hence acquire images of the user with the camera 112.

As shown in FIG. 1A, the first device 120 has a pose (e.g., position and orientation) 126 relative to the host 110 and the second device 130 has a pose 136 relative to the host 110. The poses 126 and 136 provide different perspectives, or viewpoints, of the user 140. By combining images, or images reconstructed from data structures of image data, taken from different perspectives, a three-dimensional image of the face of the user 140 may be generated.

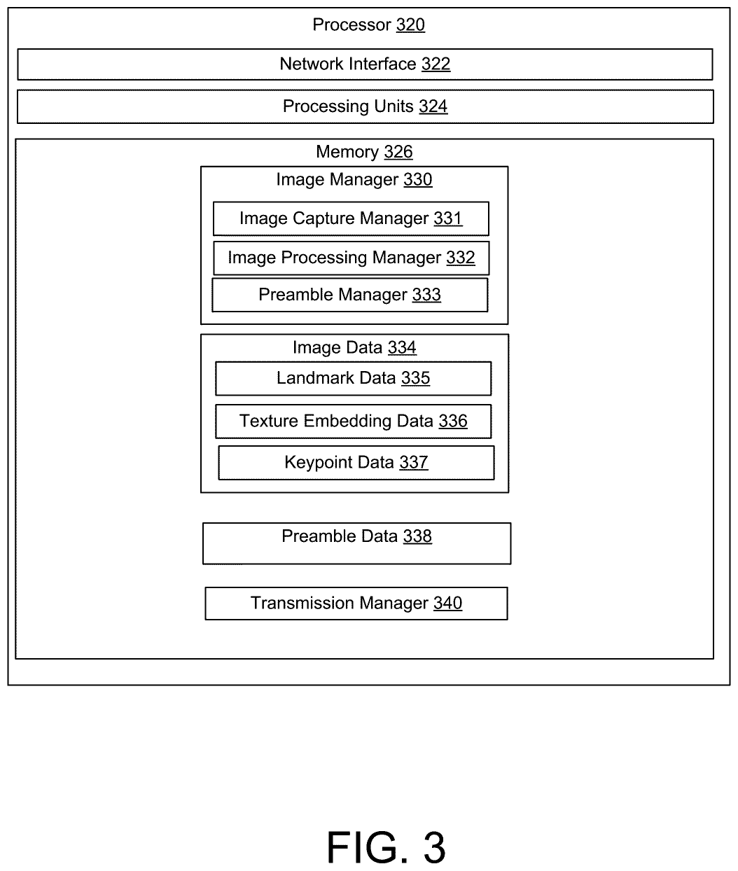

During operation, assuming that the poses 126 and 136 relative to the host 110 are known, the camera 122 of the first device 120 captures an image of the face of the user 140. In some implementations, the first device 120, e.g., a processor of the first device 120 (see processor 320 of FIG. 3) generates image data 124 based on the image captured. In some implementations, the image data 124 includes landmarks of the image. In some implementations, the image data 124 includes a texture embedding of the image. In some implementations, the image data 124 includes the image itself. In some implementations, the image data 124 includes a compressed version of the image. Upon generating the image data 124, the first device 120 sends the image data 124 to the host.

In some implementations, the first device captures the image and generates the image data 124 in response to receiving a preamble 128 from the host 110. The preamble 128 is a request from the host 110 for the image data 124. For example, if the frames sent by the host 110 are sent at a particular frame rate, then the host 110 sends preambles such as preamble 128 to the first device 120 at the frame rate. For example, the host 110 may send the preamble 128 to the first device 120 when the host 110 is generating frame data for a frame based on received image data.

As stated above, when the first device 120 generates the image data 124, the first device 120 sends the image data 124 to the host 110. In some implementations, the first device 120 also sends data indicating the pose 126 to the host. In some implementations, the first device 120 also sends the host 110 a preamble response. The preamble response includes, in some implementations, an identifier of the first device 120, e.g., an identifier of the first device 120 on the local network. In some implementations, the preamble response also includes data indicating the pose 126.

In some implementations, the second device 130, e.g., a processor of the first device 130 (see processor 320 of FIG. 3) generates image data 134 based on the image captured. In some implementations, the image data 134 includes landmarks of the image. In some implementations, the image data 134 includes a texture embedding of the image. In some implementations, the image data 134 includes the image itself. In some implementations, the image data 134 includes a compressed version of the image. Upon generating the image data 134, the first device 130 sends the image data 134 to the host.

In some implementations, the second device captures the image and generates the image data 134 in response to receiving a preamble 138 from the host 110. The preamble 138 is a request from the host 110 for the image data 134. For example, if the frames sent by the host 110 are sent at a particular frame rate, then the host 110 sends preambles such as preamble 138 to the second device 130 at the frame rate. For example, the host 110 may send the preamble 138 to the second device 130 when the host 110 is generating frame data for a frame based on received image data.

As stated above, when the second device 130 generates the image data 134, the second device 130 sends the image data 134 to the host 110. In some implementations, the second device 130 also sends data indicating the pose 136 to the host. In some implementations, the second device 130 also sends the host 110 a preamble response. The preamble response includes, in some implementations, an identifier of the second device 130, e.g., an identifier of the second device 130 on the local network.

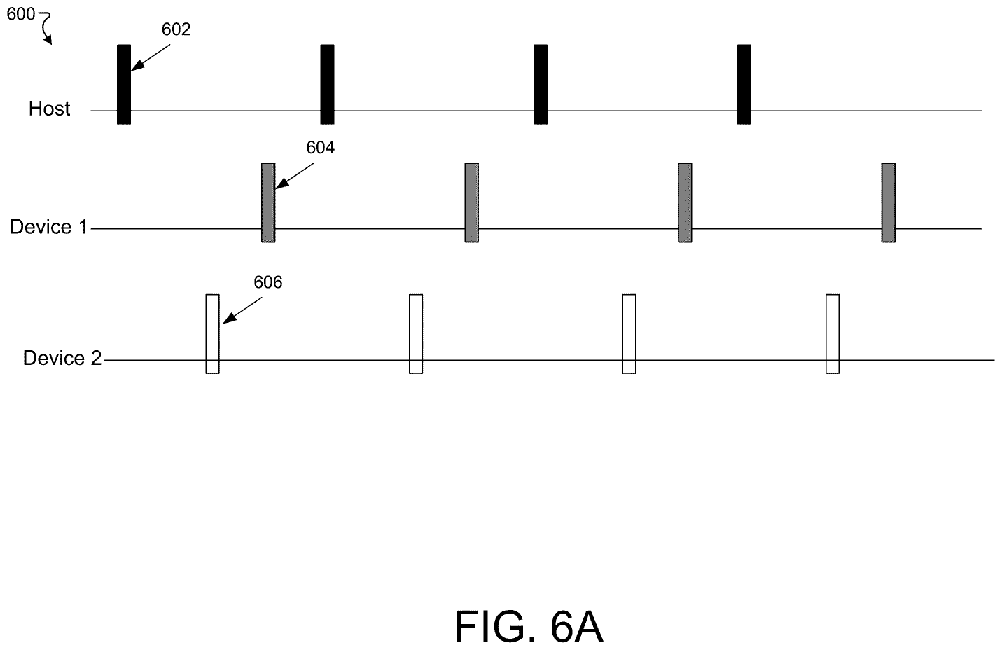

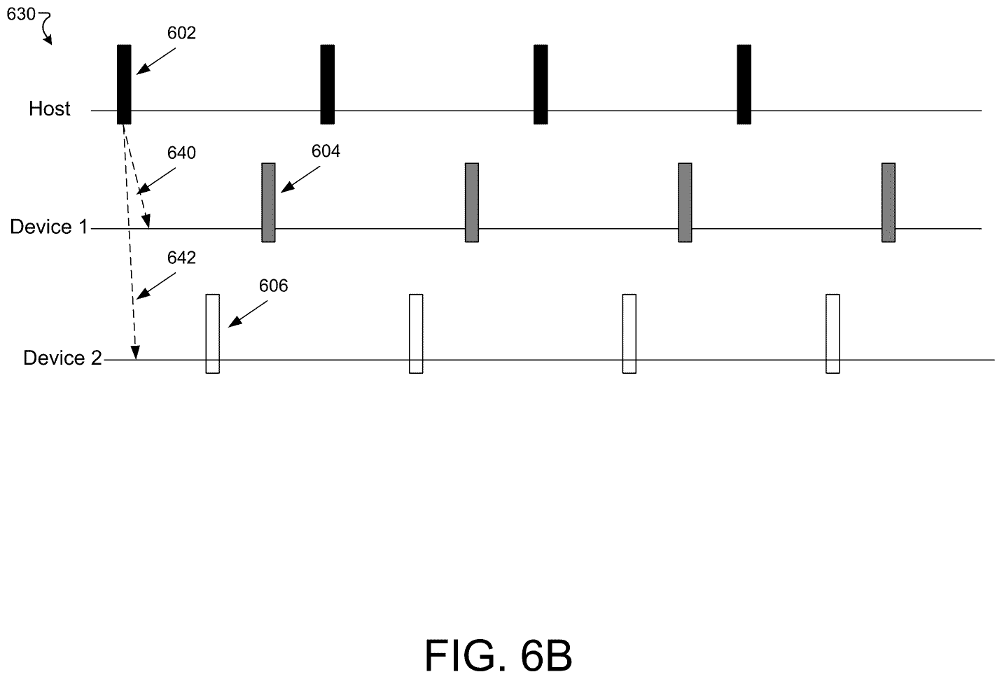

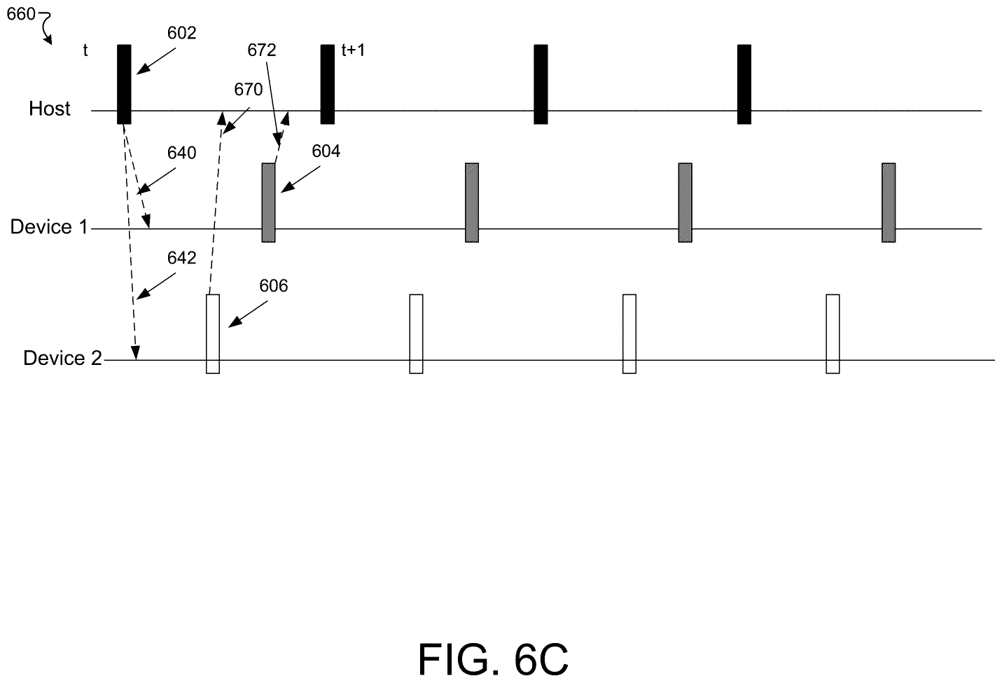

Upon receiving the image data 124 and/or 134, the host 110 begins generating frame data representing an image frame. In some implementations, the host 110 includes only one of image data 124 and image data 134 in the frame data. In some implementations, the host 110 includes both of image data 124 and image data 134 in the frame data. Whether one or both of image data 124 and 134 are included in the frame data depends on when the host 110 receives image data 124 and 134. For example, if both image data 124 and 134 are received by the host 110 within a specified segment of time, then the host 110 may include both image data 124 and 134 in the frame data for the image frame to be sent to the telepresence videoconferencing system. If, however, image data 124 and 134 are not received within the specified segment of time, then image data 124 is included in the frame data for a first frame, while image data 134 is included in the frame data for a subsequent frame. Details of the asynchronous nature of the sending and receiving of image data from different devices are discussed in further detail with regard to FIGS. 6A-6C.

In some implementations, prior to the image data 124 and 134 being generated, the host 110 determines the poses 126 and 136 using a calibration procedure. In some implementations, to determine the pose 126, both the first device 120 and the host 110 capture an image of the face of the user 140. Both the first device 120 and the host 110 generate image data representing keypoints of the face of the user 140. Because the keypoints are specified, the keypoints represented in the image data generated by the first device 120 are the same as the keypoints represented in the image data generated by the host 110. The first device 120 sends the image data to the host 110. Upon receiving the image data, the host 110 determines a correspondence between the keypoints represented by the image data of the first device 120 and the keypoints represented by the image data of the host 110. For example, the keypoints represented by the image data of the first device 120 and the keypoints represented by the image data of the host 110 may be matched using a COLMAP algorithm. Based on the correspondence between the host keypoints and the device keypoints, the pose 126 relative to the host 110 may be estimated.

In some implementations, to determine the pose 136, both the second device 130 and the host 110 capture an image of the face of the user 140. Both the second device 130 and the host 110 generate image data representing keypoints of the face of the user 140. Because the keypoints are specified, the keypoints represented in the image data generated by the second device 130 are the same as the keypoints represented in the image data generated by the host 110. The second device 130 sends the image data to the host 110. Upon receiving the image data, the host 110 determines a correspondence between the keypoints represented by the image data of the second device 130 and the keypoints represented by the image data of the host 110. For example, the keypoints represented by the image data of the second device 130 and the keypoints represented by the image data of the host 110 may be matched using a COLMAP algorithm. Based on the correspondence between the host keypoints and the device keypoints, the pose 136 relative to the host 110 may be estimated.

In some implementations, the host 110 may also capture images and generate image data for the frame data to be sent with the frames. In this case, the pose of the host 110 with respect to itself is known. In some implementations, the host 110 is able to include image data derived from an image the host 110 captured in a new frame, whereas image data from first device 120 or second device 130 may or may not be included depending on the timing of the receipt of the image data.

FIG. 1B is a diagram that illustrates an example arrangement 150 for the transmission of a representation of a 3D image (e.g., image 166) to a telepresence videoconferencing system 160. The arrangement 150 includes the host 110, the telepresence videoconferencing system 160, and a network 154. In some implementations, the network 154 is the Internet or is any network capable of transmitting data such as frame data 152(1), 152(2), . . . , 152(M) representing image frames within a specified amount of time. For example, the frame data 152(2) is sent after frame data 152(1) after an elapsed time based on a refresh rate of a display.

As described above, the host 110, generates frame data, e.g., frame data 152(1) upon receiving image data 124 and/or 134 from first device 120 and/or second device 130, or generating image data itself from images captured by host 110. In some implementations, the host 110 generates frame data 152(1) based on image data received within a segment of time, e.g., 1/60 of a second for a frame rate of 60 Hz.

In some implementations, the host 110 generates the frame data 152(1) by including the image data received within the segment of time, e.g., the landmarks and texture embedding. In some implementations, the host 110 includes in the frame data the respective pose of the device (e.g., pose 126 of first device 126 and/or pose 136 of second device 136) that sent the image data 124 and/or 134. In some implementations, the host performs a compression operation on the image data in generating the frame data 152(1).

Alternatively, in some implementations, the host 110 performs a reconstruction of the image from the image data 124 and/or 134, e.g., using a model. In some implementations, the model includes a convolutional neural network trained on landmarks and texture embeddings of images as input and reconstructed 3D images as output. In some implementations, the host 110 performs a compression operation on the reconstructed images to produce the frame data 152(1).

In some implementations, once the host 110 begins generating the frame data 152(1), the host 110 sends a preamble (e.g., preamble 128 and 138) to each of the devices (e.g., first device 120 and second device 130). Whether the host 110 receives the image data (e.g., image data 124 and/or 134) in time to generate frame data 152(2) depends on the processing speed of the devices and the host 110.

Once the frame data 152(1) has been generated, the host 110 transmits the frame data 152(1) to a telepresence videoconferencing system 160 via the network 154. As shown in FIG. 1B, the telepresence videoconferencing system 160 includes a processor 162 and a 3D display 164. In some implementations, the 3D display 164 is a 3D stereoscopic display. In some implementations, the 3D display 164 is a lenticular display. The 3D display 164 may include a set of cameras 168 used to collect images for transmitting a 3D image of another user facing the 3D display 164. In some implementations, however, for the arrangement 100, a 2D image sent from the teleconference videoconferencing system 160 via network 154 to the host 110 may be sufficient given the use of common, everyday devices in the arrangement 100.

The processor 162 of the teleconference videoconferencing system 160 is configured to receive the frame data 152(1), 152(2), . . . , 152(M) from the network 154 and reconstruct a 3D image 166 of the 3D object, e.g., the face of the user 140. In some implementations, the 3D image is displayed from the perspective of a device situated at a pose relative to the host 110. In some implementations, the device is the host 110. In some implementations, the device is one of the first device 120 or the second device 130. In some implementations, the device is none of host 110, first device 120, and second device 130.

In some implementations, when the frame data 152(1) includes landmarks and a texture embedding of each image captured by a device as part of the image data sent by that device and the pose of the device relative to the host 110, the processor 162 defines a 3D image 166 of the object, e.g., the face of the user 140 based on the landmarks, texture embedding, and pose relative to the host 110. That is, the 3D image 166 displayed on the 3D display 164 is reconstructed from landmarks and texture embeddings taken from images captured from different perspectives, e.g., captured by devices situated at different poses with respect to the host 110. In some implementations, the 3D image 166 displayed on the 3D display 164 from the perspective of the host 110.

In some implementations, the processor 162 defines the 3D image 166 from the landmarks and texture embeddings using a model. In some implementations, the model includes a convolutional neural network trained on landmarks and texture embeddings of images as input and reconstructed 3D images as output.

In some implementations, when the frame data 152(1) includes a compressed reconstructed 3D image of the 3D object, e.g., the face of the user 140, the processor 162 performs a decompression on the compressed reconstructed 3D image of the 3D object to produce the 3D image of the 3D object for display on the 3D display, e.g., the 3D image 166.

In some implementations, there is some jitter between frames, e.g., between frames represented by frame data 152(1) and 152(2). In such implementations, the processor 162 may apply a temporal filter after reconstruction of the images in order to reduce the jitter. For example, a temporal filter can perform a convolution of the reconstructed images over time with a temporal smoothing kernel, e.g., a Gaussian.

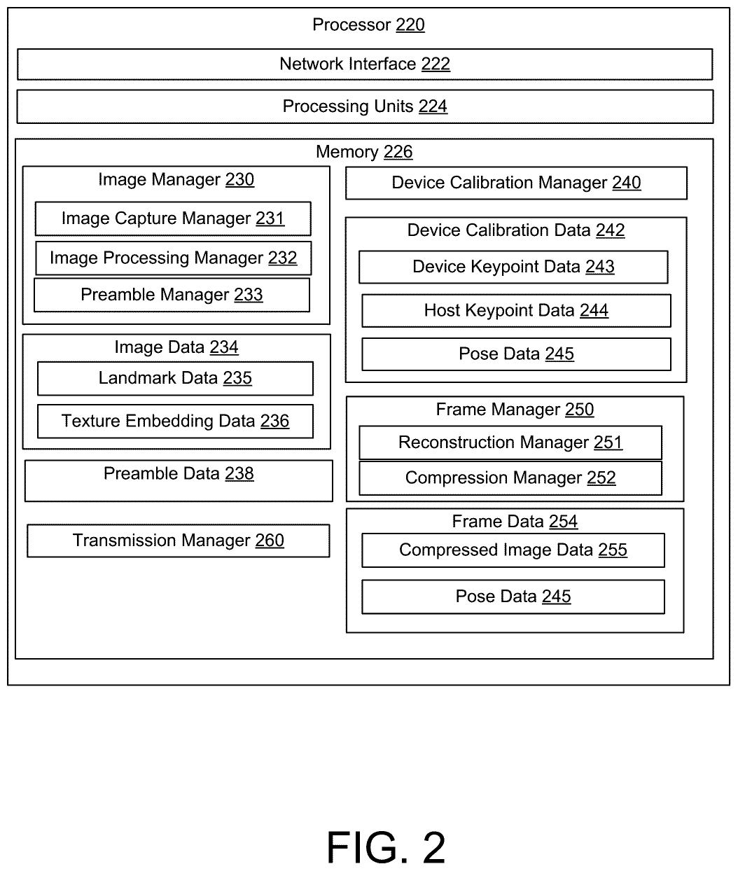

FIG. 2 is a diagram that illustrates an example electronic environment of the host 110. As shown in FIG. 2, the host 110 includes a processor 220.

The processor 220 includes a network interface 222, one or more processing units 224, and nontransitory memory 226. The network interface 222 includes, for example, Ethernet adaptors, Bluetooth adaptors, and the like, for converting electronic and/or optical signals received from the network to electronic form for use by the processor 220. The set of processing units 224 include one or more processing chips and/or assemblies. The memory 226 is a storage medium and includes both volatile memory (e.g., RAM) and non-volatile memory, such as one or more read only memories (ROMs), disk drives, solid state drives, and the like. The set of processing units 224 and the memory 226 together form part of the processor 220, which is configured to perform various methods and functions as described herein as a computer program product.

In some implementations, one or more of the components of the processor 220 can be, or can include processors (e.g., processing units 224) configured to process instructions stored in the memory 226. Examples of such instructions as depicted in FIG. 2 include an image manager 230, a device calibration manager 240, a frame manager 250, and a transmission manager 260. Further, as illustrated in FIG. 2, the memory 226 is configured to store various data, which is described with respect to the respective managers that use such data.

The image manager 230 is configured to process images of a 3D object situated in front of the host 110 to produce image data 234. For example, the image manager 230 is configured to receive image data from each device in the local network. As shown in FIG. 2, the image manager 230 includes an image capture manager 231, an image processing manager 232, and a preamble manager 233.

The image capture manager 231 is configured to capture images of the 3D object using, e.g., the camera 112 of host 110 to produce the image data 234.

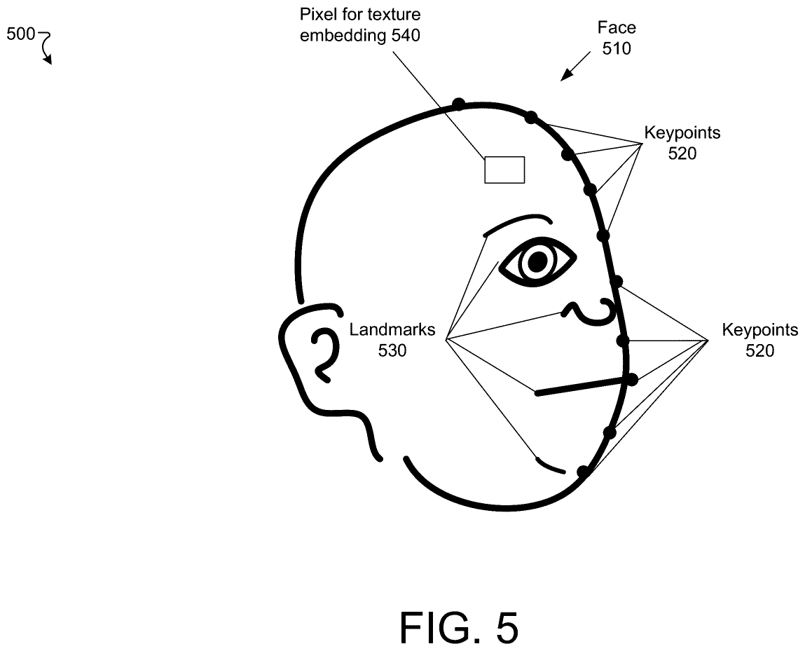

The image processing manager 232 is configured to generate keypoints, landmarks, and texture embeddings from image data 234. As shown in FIG. 2, the keypoints are stored as host keypoint data 244, the landmarks are stored as landmark data 235, and the texture embeddings are stored as texture embedding data 236. The landmark data 244 and texture embedding data 245 also represent landmarks and texture embeddings sent to the host 110 from the devices (e.g., first device 120 and second device 130) as part of the image data (e.g., image data 124 and/or 134). Further details concerning the keypoints, landmarks, and texture embeddings are described with regard to FIG. 5.

FIG. 5 is a diagram that illustrates example image data used in reconstructing three-dimensional images of a user 500 and calibrating the devices to the host 110. As shown in FIG. 5, the image data are largely derived from a face 510 of the user 500. The image data include keypoints 520, landmarks 530, and a pixel of a plurality of pixels used for generating a texture embedding 540.

FIG. 5 illustrates example keypoints 520 on the face 510 of the user 500. The keypoints 520 are distributed about the face 510 from the top of the face 510 at the top of the forehead to the bottom of the face by the chin. In principle, the keypoints 520 can be anywhere on the face that may be easily identifiable, e.g., in the center of the eyes, the tip of the nose, the corners of the mouth, and the chin. In some implementations, the keypoints 520 are represented as coordinates in three dimensions. In some implementations, there are a specified number of keypoints 520; the specified number is a minimum needed to accurately estimate the pose of a device with respect to the host.

The landmarks 530 represents features of the face 510 that enable the host or a device to distinguish between different faces. The landmarks represent contours of the parts of the user's face at designated parts of the face. As shown in FIG. 5, the landmarks 530 represent an eyebrow, a corner of an eye, a nose, a mouth, and a chin. Such landmarks may be identified using, e.g., a model. For example, such a model may include a computer vision system configured to identify the landmarks 530. Each of the landmarks 530 is represented as a set of points in two or three dimensions that forms a contour approximating the feature of face 510.

The pixel 540 is one of a plurality of pixels representing the face 510. The pixel 540 has texture attributes, e.g., color and lighting. The color may be expressed in a RBG representation, while the lighting may be represented by a bidirectional reflectance distribution function. Because the plurality of pixels forms a large amount of data, it is preferred to represent the plurality of pixels as a texture embedding, which is a vector of numbers having a dimension much smaller than that of the plurality of pixels. The texture embeddings are derived from the plurality of pixels via a model, e.g., a convolutional neural network.

Returning to FIG. 2, the preamble manager 233 is configured to generate preambles represented by preamble data 238 and send the preambles to respective devices, e.g., first device 120 and second device 130. In some implementations, the preamble manager 233 sends preambles to the devices in response to the frame manager 250 generating frame data 254. The preambles are sent in recognition that devices such as the first device 120 and the second device 130 generate image data, e.g., image data 124 and 134 asynchronously. Such asynchronous generation of the image data, e.g., at different times, can result in the reconstructed 3D image being warped. Further details concerning timings of the preambles are shown with regard to FIGS. 6A, 6B, and 6C.

FIGS. 6A, 6B, and 6C are diagrams that illustrate an example embedding timing diagram representing a timing of the acquiring of the embeddings in asynchronous devices such that a warping behavior is avoided.

FIG. 6A illustrates the timing 600 of image capture in the host, e.g., host 110 and devices, e.g., first device 120 and second device 130. As shown in FIG. 6A, there are two devices under consideration, Device 1 and Device 2. The host and devices are asynchronous in that they perform image capture at different times. In the example shown in FIG. 6A, the host performs an image capture 602 and the devices perform image captures 604 and 606 at different times, e.g., between frames.

Moreover, in some implementations, the processing of the images, e.g., to acquire texture embeddings and landmarks, takes different amounts of time for the host and the devices. For example, the host may have more processing power than the devices and can process the captured images faster.

FIG. 6B illustrates a solution 630 to the problem of the host device acquiring landmarks and texture embeddings from asynchronous devices. As soon as the host's texture embeddings and landmarks are determined for a frame, preambles 640 and 642 (dashed arrows) for requesting texture embeddings and landmarks are sent out to the devices. The preamble contains instructions for the devices to send image data, e.g., landmark and texture embedding data, to the host.

In some implementations, the frequency of sending preambles is dependent on the image quality desired. That is, the frequency of sending preambles may be tied to an image refresh rate at the telepresence videoconferencing system. Nevertheless, the preambles 640 and 642 as shown in FIG. 6B are sent when the host processes its image data to generate frame data.

FIG. 6C illustrates the solution 660 in which responses 670 and 672 to the preambles 640 and 642, respectively from the devices. The devices may respond to the preambles by sending their own preambles that identify the devices, as well as the latest landmark and texture embeddings to the host. As soon as a device receives a preamble, e.g., 642, it begins capture and processing of an image to produce landmarks and texture embeddings. The device then sends a preamble response, e.g., 672 along with the processed image data (e.g., landmarks and texture embeddings) as soon as the image data has been processed.

The host, upon receiving the preamble responses 670 and 672 and processed image data, performs a reconstruction on the texture embeddings received between time “t” at which the host sent the preambles 640 and 642 and time “t+1” at which the next frame is processed as “t” progresses. This allows the host to estimate the timings of the image captures and better match the texture embeddings.

Moreover, the host can adjust the rate at which preambles 640 and 642 are sent based on a dynamic bandwidth. For example, if the bandwidth of the local network initially allows polling at 60 Hz, but the bandwidth suddenly drops, the host can drop the preamble rate to 30 Hz so that there is not a lot of backlog at the devices.

The device calibration manager 240 is configured to perform the calibration procedure based on device calibration data 242 and determine poses of the devices with respect to the host 110, as represented by pose data 245. In some implementations, to determine a pose represented by pose data 245, the device calibration manager 240 receives device keypoint data 243 from a device (e.g., first device 120). Upon receiving the image data, the device calibration manager 240 determines a correspondence between the keypoints represented by the device keypoint data 243 and the keypoints represented by the host keypoint data 244. For example, the keypoints represented by the device keypoint data 243 and the keypoints represented by the host keypoint data 244 may be matched using a COLMAP algorithm. Based on the correspondence between the keypoints represented by the device keypoint data 243 and the keypoints represented by the host keypoint data 244, the pose represented by the host data 245 may be estimated.

The frame manager 250 is configured to generate frame data 254 for transmission to the telepresence videoconferencing system 160. The frame data 254 includes data to be sent at a frame rate to the remote system from which the telepresence videoconferencing system 160 may reconstruct a 3D image, e.g., 3D image 166 for display on a 3D display, e.g., 3D display 168.

How the frame manager 250 generates frame data 254 depends on the content of the image data 234. For example, when the image data 234 includes landmark data 235 and texture embedding data 236, the frame manager 250 may simply include the landmark data 235 and texture embedding data 236 in the frame data as is. In some implementations, the frame manager compresses the landmark data 235 and texture embedding data 236 to produce compressed image data 255 included in the frame data 254. In some implementations, the frame data takes the form of a large data packet.

In some implementations and as shown in FIG. 2, the frame manager 250 includes a reconstruction manager 251 and compression manager 252. The reconstruction manager 251 is configured to perform a reconstruction of a 3D image of the 3D object based on the landmark data 235 and texture embedding data 236. The compression manager 252 is configured to perform a compression (e.g., JPEG) of the 3D image to produce compressed image data 255. The compressed image data 255 is included in the frame data 254.

As described above, the pose data 245 is also included in the frame data. This helps the telepresence videoconferencing system 160 perform a reconstruction of the 3D image when the frame data includes the landmark data 235 and the texture embedding data 236.

The transmission manager 260 is configured to transmit the frame data 254 to the telepresence videoconferencing system 160 over, e.g., the network 154 at a specified frame rate.

The components (e.g., modules, processing units 224) of processor 220 can be configured to operate based on one or more platforms (e.g., one or more similar or different platforms) that can include one or more types of hardware, software, firmware, operating systems, runtime libraries, and/or so forth. In some implementations, the components of the processor 220 can be configured to operate within a cluster of devices (e.g., a server farm). In such an implementation, the functionality and processing of the components of the processor 220 can be distributed to several devices of the cluster of devices.

The components of the processor 220 can be, or can include, any type of hardware and/or software configured to process attributes. In some implementations, one or more portions of the components shown in the components of the processor 220 in FIG. 2 can be, or can include, a hardware-based module (e.g., a digital signal processor (DSP), a field programmable gate array (FPGA), a memory), a firmware module, and/or a software-based module (e.g., a module of computer code, a set of computer-readable instructions that can be executed at a computer). For example, in some implementations, one or more portions of the components of the processor 220 can be, or can include, a software module configured for execution by at least one processor (not shown). In some implementations, the functionality of the components can be included in different modules and/or different components than those shown in FIG. 2, including combining functionality illustrated as two components into a single component.

Although not shown, in some implementations, the components of the processor 220 (or portions thereof) can be configured to operate within, for example, a data center (e.g., a cloud computing environment), a computer system, one or more server/host devices, and/or so forth. In some implementations, the components of the processor 220 (or portions thereof) can be configured to operate within a network. Thus, the components of the processor 220 (or portions thereof) can be configured to function within various types of network environments that can include one or more devices and/or one or more server devices. For example, the network can be, or can include, a local area network (LAN), a wide area network (WAN), and/or so forth. The network can be, or can include, a wireless network and/or wireless network implemented using, for example, gateway devices, bridges, switches, and/or so forth. The network can include one or more segments and/or can have portions based on various protocols such as Internet Protocol (IP) and/or a proprietary protocol. The network can include at least a portion of the Internet.

In some implementations, one or more of the components of the search system can be, or can include, processors configured to process instructions stored in a memory. For example, image manager 230 (and/or a portion thereof), device calibration manager 240 (and/or a portion thereof), frame manager 250 (and/or a portion thereof), and transmission manager 260 (and/or a portion thereof) are examples of such instructions.

In some implementations, the memory 226 can be any type of memory such as a random-access memory, a disk drive memory, flash memory, and/or so forth. In some implementations, the memory 226 can be implemented as more than one memory component (e.g., more than one RAM component or disk drive memory) associated with the components of the processor 220. In some implementations, the memory 226 can be a database memory. In some implementations, the memory 226 can be, or can include, a non-local memory. For example, the memory 226 can be, or can include, a memory shared by multiple devices (not shown). In some implementations, the memory 226 can be associated with a server device (not shown) within a network and configured to serve the components of the processor 220. As illustrated in FIG. 2, the memory 226 is configured to store various data, including image data 234 and frame data 254.

FIG. 3 is a diagram that illustrates an example electronic environment of a device, e.g., first device 120. The device includes a processor 320.

The processor 320 includes a network interface 322, one or more processing units 324, and nontransitory memory 326. The network interface 322 includes, for example, Ethernet adaptors, Bluetooth adaptors, and the like, for converting electronic and/or optical signals received from the network to electronic form for use by the processor 320. The set of processing units 324 include one or more processing chips and/or assemblies. The memory 326 is a storage medium and includes both volatile memory (e.g., RAM) and non-volatile memory, such as one or more read only memories (ROMs), disk drives, solid state drives, and the like. The set of processing units 324 and the memory 326 together form part of the processor 320, which is configured to perform various methods and functions as described herein as a computer program product.

In some implementations, one or more of the components of the processor 320 can be, or can include processors (e.g., processing units 324) configured to process instructions stored in the memory 326. Examples of such instructions as depicted in FIG. 3 include an image manager 330 and a transmission manager 340. Further, as illustrated in FIG. 3, the memory 326 is configured to store various data, which is described with respect to the respective managers that use such data.

The image manager 330 is configured to capture and process images of a 3D object situated in front of the host 110 to produce image data 234. As shown in FIG. 3, the image manager 330 includes an image capture manager 331, an image processing manager 332, and a preamble manager 333.

The image capture manager 331 is configured to capture images of the 3D object using, e.g., the camera 122 of first device 120 to produce the image data 334. The image capture manager 331 is configured to capture the images in response to receiving a preamble from the host (e.g., host 110).

The image processing manager 332 is configured to generate keypoints, landmarks, and texture embeddings to form image data 334. The keypoints, landmarks, and texture embeddings have been described above with regard to FIG. 5. As shown in FIG. 3, the keypoints are stored as host keypoint data 337, the landmarks are stored as landmark data 335, and the texture embeddings are stored as texture embedding data 336.

The preamble manager 333 is configured to receive preambles from the host (e.g., host 110) so that the image capture manager 331 captures an image of the 3D object in response. The preamble manager 333 is also configured to generate a preamble response to a preamble after the image processing manager 332 generates the image data 334. In some implementations, the preamble response includes an identifier of the device, e.g., a network identifier of the device.

The transmission manager 340 is configured to send the image data 334 to the host, e.g., host 110 over the local network.

The components (e.g., modules, processing units 324) of processor 320 can be configured to operate based on one or more platforms (e.g., one or more similar or different platforms) that can include one or more types of hardware, software, firmware, operating systems, runtime libraries, and/or so forth. In some implementations, the components of the processor 320 can be configured to operate within a cluster of devices (e.g., a server farm). In such an implementation, the functionality and processing of the components of the processor 320 can be distributed to several devices of the cluster of devices.

The components of the processor 320 can be, or can include, any type of hardware and/or software configured to process attributes. In some implementations, one or more portions of the components shown in the components of the processor 320 in FIG. 3 can be, or can include, a hardware-based module (e.g., a digital signal processor (DSP), a field programmable gate array (FPGA), a memory), a firmware module, and/or a software-based module (e.g., a module of computer code, a set of computer-readable instructions that can be executed at a computer). For example, in some implementations, one or more portions of the components of the processor 320 can be, or can include, a software module configured for execution by at least one processor (not shown). In some implementations, the functionality of the components can be included in different modules and/or different components than those shown in FIG. 3, including combining functionality illustrated as two components into a single component.

Although not shown, in some implementations, the components of the processor 320 (or portions thereof) can be configured to operate within, for example, a data center (e.g., a cloud computing environment), a computer system, one or more server/host devices, and/or so forth. In some implementations, the components of the processor 320 (or portions thereof) can be configured to operate within a network. Thus, the components of the processor 320 (or portions thereof) can be configured to function within various types of network environments that can include one or more devices and/or one or more server devices. For example, the network can be, or can include, a local area network (LAN), a wide area network (WAN), and/or so forth. The network can be, or can include, a wireless network and/or wireless network implemented using, for example, gateway devices, bridges, switches, and/or so forth. The network can include one or more segments and/or can have portions based on various protocols such as Internet Protocol (IP) and/or a proprietary protocol. The network can include at least a portion of the Internet.

In some implementations, one or more of the components of the search system can be, or can include, processors configured to process instructions stored in a memory. For example, image manager 330 (and/or a portion thereof) and transmission manager 340 (and/or a portion thereof) are examples of such instructions.

In some implementations, the memory 326 can be any type of memory such as a random-access memory, a disk drive memory, flash memory, and/or so forth. In some implementations, the memory 326 can be implemented as more than one memory component (e.g., more than one RAM component or disk drive memory) associated with the components of the processor 320. In some implementations, the memory 326 can be a database memory. In some implementations, the memory 326 can be, or can include, a non-local memory. For example, the memory 326 can be, or can include, a memory shared by multiple devices (not shown). In some implementations, the memory 326 can be associated with a server device (not shown) within a network and configured to serve the components of the processor 320. As illustrated in FIG. 3, the memory 326 is configured to store various data, including image data 334 and preamble data 338.

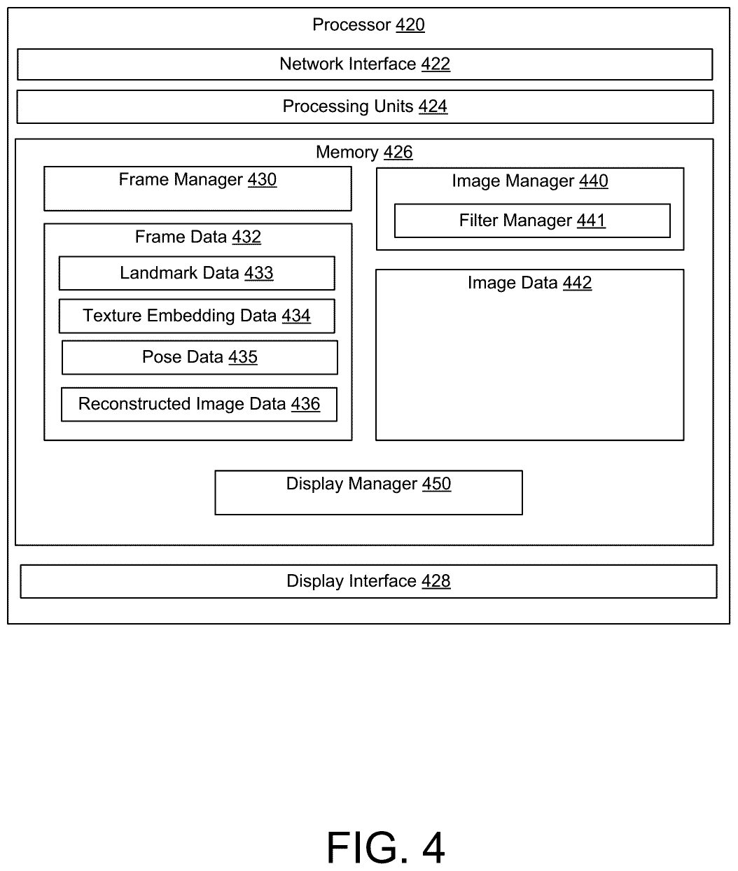

FIG. 4 is a diagram that illustrates an example electronic environment of a telepresence videoconferencing system, e.g., telepresence videoconferencing system 160. The telepresence videoconferencing system includes a processor 420, e.g., processor 162 of FIG. 1B.

The processor 420 includes a network interface 422, one or more processing units 424, and nontransitory memory 426, and a display interface 428. The network interface 422 includes, for example, Ethernet adaptors, Bluetooth adaptors, and the like, for converting electronic and/or optical signals received from the network to electronic form for use by the processor 420. The set of processing units 424 include one or more processing chips and/or assemblies. The memory 426 is a storage medium and includes both volatile memory (e.g., RAM) and non-volatile memory, such as one or more read only memories (ROMs), disk drives, solid state drives, and the like. The set of processing units 424 and the memory 426 together form part of the processor 420, which is configured to perform various methods and functions as described herein as a computer program product.

In some implementations, one or more of the components of the processor 420 can be, or can include processors (e.g., processing units 424) configured to process instructions stored in the memory 426. Examples of such instructions as depicted in FIG. 4 include a frame manager 430, an image manager 440, and a display manager 450. Further, as illustrated in FIG. 4, the memory 426 is configured to store various data, which is described with respect to the respective managers that use such data.

The frame manager 430 is configured to receive frame data 432 over a network, e.g., network 154. As shown in FIG. 4, the frame data 432 can include landmark data 433 representing landmarks of images, texture embedding data 434 representing texture embeddings of images, and pose data 435 representing poses of devices that captured the images. Alternatively, the frame data 432 can include reconstructed image data 436 that has been compressed by the host, e.g., host 110.

The image manager 440 is configured to generate image data 442 representing a 3D image from the frame data 432. For example, when the frame data 432 includes the landmark data 433, texture embedding data 434, and pose data 435, the image manager 440 is configured to perform a reconstruction on the landmark data 433, texture embedding data 434, and pose data 435 to produce the image data 442. In some implementations, the reconstruction is performed using a model, e.g., a convolutional neutral network decoder that is configured to construct a three-dimensional image from the landmarks, the texture embedding, and relative position and orientation.

As shown in FIG. 4, the image manager 440 can include a filter manager 441. The filter manager 441 is configured to reduce jitter between frames represented by frame data, e.g., frame data 432. The filter manager 441 may apply a temporal filter after reconstruction of the images in order to reduce the jitter. For example, a temporal filter can perform a convolution of the reconstructed images over time with a temporal smoothing kernel, e.g., a Gaussian.

The display manager 450 is configured to display the image data 442 as a 3D image on a 3D display, e.g., 3D display 164 via display interface 428.

The components (e.g., modules, processing units 424) of processor 420 can be configured to operate based on one or more platforms (e.g., one or more similar or different platforms) that can include one or more types of hardware, software, firmware, operating systems, runtime libraries, and/or so forth. In some implementations, the components of the processor 420 can be configured to operate within a cluster of devices (e.g., a server farm). In such an implementation, the functionality and processing of the components of the processor 420 can be distributed to several devices of the cluster of devices.

The components of the processor 420 can be, or can include, any type of hardware and/or software configured to process attributes. In some implementations, one or more portions of the components shown in the components of the processor 420 in FIG. 4 can be, or can include, a hardware-based module (e.g., a digital signal processor (DSP), a field programmable gate array (FPGA), a memory), a firmware module, and/or a software-based module (e.g., a module of computer code, a set of computer-readable instructions that can be executed at a computer). For example, in some implementations, one or more portions of the components of the processor 420 can be, or can include, a software module configured for execution by at least one processor (not shown). In some implementations, the functionality of the components can be included in different modules and/or different components than those shown in FIG. 4, including combining functionality illustrated as two components into a single component.

Although not shown, in some implementations, the components of the processor 420 (or portions thereof) can be configured to operate within, for example, a data center (e.g., a cloud computing environment), a computer system, one or more server/host devices, and/or so forth. In some implementations, the components of the processor 420 (or portions thereof) can be configured to operate within a network. Thus, the components of the processor 420 (or portions thereof) can be configured to function within various types of network environments that can include one or more devices and/or one or more server devices. For example, the network can be, or can include, a local area network (LAN), a wide area network (WAN), and/or so forth. The network can be, or can include, a wireless network and/or wireless network implemented using, for example, gateway devices, bridges, switches, and/or so forth. The network can include one or more segments and/or can have portions based on various protocols such as Internet Protocol (IP) and/or a proprietary protocol. The network can include at least a portion of the Internet.

In some implementations, one or more of the components of the search system can be, or can include, processors configured to process instructions stored in a memory. For example, frame manager 430 (and/or a portion thereof), image manager 440 (and/or a portion thereof), and display manager 450 (and/or a portion thereof) are examples of such instructions.

In some implementations, the memory 426 can be any type of memory such as a random-access memory, a disk drive memory, flash memory, and/or so forth. In some implementations, the memory 426 can be implemented as more than one memory component (e.g., more than one RAM component or disk drive memory) associated with the components of the processor 420. In some implementations, the memory 426 can be a database memory. In some implementations, the memory 426 can be, or can include, a non-local memory. For example, the memory 426 can be, or can include, a memory shared by multiple devices (not shown). In some implementations, the memory 426 can be associated with a server device (not shown) within a network and configured to serve the components of the processor 420. As illustrated in FIG. 4, the memory 426 is configured to store various data, including frame data 432 and image data 442.

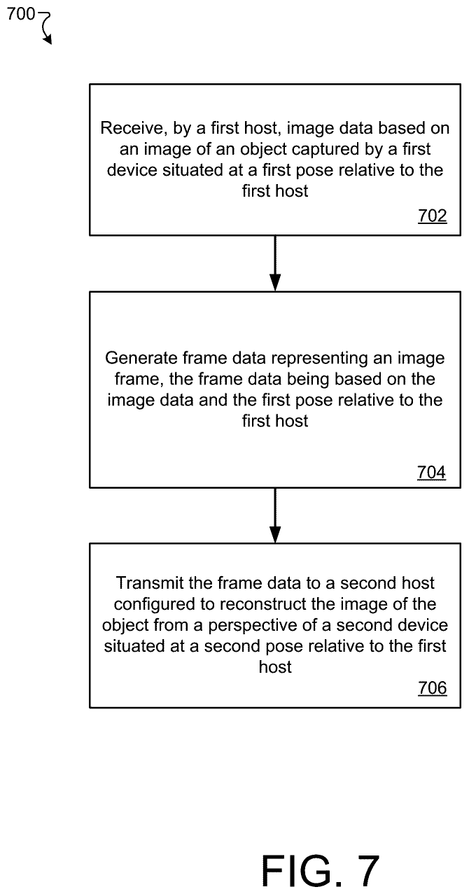

FIG. 7 is a flow chart that illustrates an example method 100 of generating data for images at systems such as telepresence videoconferencing systems from at least one device. The method 100 may be performed on a processor such as processor 220.

At 702, an image manager (e.g., image manager 230) receives, by a first host (e.g., host 110), image data (e.g., image data 124) based on an image of an object (e.g., face 510) captured by a first device (e.g., first device 120) situated at a first pose (e.g., pose 126) relative to the first host.

At 702, a frame manager (e.g., frame manager 250) generates frame data (e.g., frame data 152(1)) representing an image frame, the frame data being based on the image data and the first pose relative to the first host.

At 704, a transmission manager (e.g., transmission manager 260) transmits the frame data to a second host (e.g., telepresence videoconferencing system 160) configured to reconstruct the image of the object from a perspective of a second device (e.g., host 110) situated at a second pose relative to the first host.

In some aspects, the techniques described herein relate to a method as described above with regard to FIG. 7. Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube), LED, OLED, or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In this specification and the appended claims, the singular forms “a,” “an” and “the” do not exclude the plural reference unless the context clearly dictates otherwise. Further, conjunctions such as “and,” “or,” and “and/or” are inclusive unless the context clearly dictates otherwise. For example, “A and/or B” includes A alone, B alone, and A with B. Further, connecting lines or connectors shown in the various figures presented are intended to represent exemplary functional relationships and/or physical or logical couplings between the various elements. Many alternative or additional functional relationships, physical connections or logical connections may be present in a practical device. Moreover, no item or component is essential to the practice of the embodiments disclosed herein unless the element is specifically described as “essential” or “critical”.

Terms such as, but not limited to, approximately, substantially, generally, etc. are used herein to indicate that a precise value or range thereof is not required and need not be specified. As used herein, the terms discussed above will have ready and instant meaning to one of ordinary skill in the art.

Moreover, use of terms such as up, down, top, bottom, side, end, front, back, etc. herein are used with reference to a currently considered or illustrated orientation. If they are considered with respect to another orientation, it should be understood that such terms must be correspondingly modified.

Further, in this specification and the appended claims, the singular forms “a,” “an” and “the” do not exclude the plural reference unless the context clearly dictates otherwise. Moreover, conjunctions such as “and,” “or,” and “and/or” are inclusive unless the context clearly dictates otherwise. For example, “A and/or B” includes A alone, B alone, and A with B.

Although certain example methods, apparatuses and articles of manufacture have been described herein, the scope of coverage of this patent is not limited thereto. It is to be understood that terminology employed herein is for the purpose of describing particular aspects, and is not intended to be limiting. On the contrary, this patent covers all methods, apparatus and articles of manufacture fairly falling within the scope of the claims of this patent.

What is claimed is:

1. A method, comprising:
receiving, by a first host, image data based on a first image of an object captured by a first device in a first pose relative to the first host;
generating frame data representing an image frame, the frame data being based on the image data and the first pose relative to the first host; and
transmitting the frame data to a second host configured to define a second image of the object from a perspective of a second device situated at a second pose relative to the first host.

2. The method as in claim 1, wherein the first image of the object includes a plurality of pixels; and
wherein the image data includes a texture embedding based on the plurality of pixels, the texture embedding representing a texture of the object, the texture embedding including a vector of numbers representing the plurality of pixels.

3. The method as in claim 1, wherein the image data includes a plurality of points representing locations of a landmark of the object, the landmark of the object being a feature of the object that enables the first host to distinguish between the object and another object.

4. The method as in claim 3, wherein the object is a face, and the landmark of the object includes at least one of a nose, an eyebrow, a chin, a mouth, and corners of an eye.

5. The method as in claim 1, wherein generating the frame data includes:
reconstructing the first image of the object using the image data to form a reconstructed image of the object; and
producing the frame data by compressing the reconstructed image of the object and data representing the first pose at which the first device is situated relative to the first host.

6. The method as in claim 1, further comprising:
determining the first pose at which the first device is situated relative to the first host.

7. The method as in claim 6, wherein determining the first pose at which the first device is situated relative to the first host includes:
receiving device data based on a calibration image of the object captured by the first device;
generating host data based on a host image of the object captured by the first host;
wherein the first pose at which the first device is situated relative to the first host is based on the device data and the host data.

8. The method as in claim 7, wherein the device data includes device keypoints of the calibration image, the device keypoints representing specified points of the object;
wherein the host data includes host keypoints of the host image, the host keypoints representing specific points of the object; and
wherein determining the first pose at which the first device is situated relative to the first host includes:
deriving a correspondence between at least one of the device keypoints and at least one of the host keypoints, the first pose being based on the correspondence.

9. The method as in claim 1, wherein the image data is device image data and the first image is a device image,
wherein the method further comprises generating host image data based on a host image of the object captured by the first host; and
wherein the frame data is further based on the host image data.

10. The method as in claim 1, further comprising:
sending a preamble to the first device, the preamble including instructions for the first device to send the image data to the first host, wherein the image data is received after the preamble is sent to the first device.

11. The method as in claim 10, further comprising:
receiving a response to the preamble identifying the first device, wherein the frame data is generated in response to receipt of the response to the preamble.

12. The method as in claim 10, wherein the image data is device image data and the first image is a device image,
wherein the method further comprises generating host image data based on a host image of the object captured by the first host; and
wherein the preamble is sent in response to the host image data being generated.

13. The method as in claim 10, wherein the preamble is a first preamble, and
wherein the method further comprises sending a second preamble to the first device after an amount of time determined by a specified frequency.

14. The method as in claim 13, wherein the specified frequency is based on a refresh rate of the second host.

15. The method as in claim 1, wherein the second host includes a telepresence videoconferencing system.

16. A system, comprising:
a first device, comprising:
memory; and
processing circuitry coupled to the memory, the processing circuitry being configured to:
capture a first image of an object;
generate image data based on the first image of the object; and
send the image data to a first host, wherein the first device is situated at a first pose relative to the first host,
the first host, comprising:
memory; and
processing circuitry coupled to the memory, the processing circuitry being configured to:
receive the image data;
generate frame data representing an image frame, the frame data being based on the image data and the first pose relative to the first host; and
transmit the frame data to a second host, and
the second host, comprising:
memory; and
processing circuitry coupled to the memory, the processing circuitry being configured to:
receive the frame data; and
define, from the frame data, a second image of the object from a perspective of a second device situated at a second pose relative to the first host.

17. The system as in claim 16, wherein the second device is the first host.

18. The system as in claim 16, wherein frame data is first frame data, and
wherein the processing circuitry of the second host is further configured to:
receive second frame data;
define, from the second frame data, a third image of the object from the perspective of the second device; and
apply a temporal filter to the second image and the third image.

19. The system as in claim 18, wherein the second frame data is sent from the first host after an elapsed time after the first frame data based on a refresh rate of the second host.

20. The system as in claim 16, wherein the processing circuitry of the first host is further configured to:
send a preamble to the first device, the preamble including instructions for the first device to send the image data to the first host, and
wherein the processing circuitry of the first device is further configured to:
receive the preamble, wherein the first image of the object is captured and
the image data is generated in response to receipt of the preamble;
generate a response to the preamble identifying the first device; and
send the image data and the response to the preamble to the first device.
